(19) United States
(12) Patent Application Publication
(10) Pub. No.: US 2026/0272140 A1
(43) Pub. Date: Sep. 17, 2026

(54) ERGONOMIC COMB HOLDER

(71) Applicant: Roy Roger Dunlap, Richfield, MN (US)

(72) Inventor: Roy Roger Dunlap, Richfield, MN (US)

(21) Appl. No.: 19/563,035

(22) Filed: Mar. 11, 2026

Related U.S. Application Data
(60) Provisional application No. 63/770,112, filed on Mar. 11, 2025.

(51) Int. Cl. A45D 24/02; A45D 24/00; B25G 1/10; B25G 3/10

(52) U.S. Cl. CPC A45D 24/02; B25G 1/102; B25G 3/10; A45D 2024/002

(57) ABSTRACT

The invention provides devices and methods that are useful for reducing cumulative trauma disorders in the barber and hair stylist industry.

### CROSS-REFERENCE TO RELATED APPLICATION

This application claims priority to U.S. Provisional Application Ser. No. 63/770,112 that was filed on Mar. 11, 2025. The entire content of the applications referenced above is hereby incorporated by reference herein.

### BACKGROUND

Prolonged pincher grip position and wrist flexion are known to cause Cumulative Trauma Disorders or CTDs including carpal tunnel syndrome, tendonitis, trigger finger, and repetitive strain injuries which involve the fingers, hands, wrist, forearm, and elbow. Hairstylists experience carpal tunnel syndrome at a rate that is five-times that of the national.

The U.S. Army Environmental Hygiene Agency CTD Task Force has outlined the following solutions to hand tool health problems (The U.S. Army Safety Center/U.S. Army Environmental Hygiene Agency CTD Task Force, Preventing Cumulative Trauma Disorders in the Workplace July 1992). Ideally, hand tools should be designed so that, during tool use, the wrist is maintained in a neutral or relaxed position such as when the arm hangs relaxed at one's side. Handles should distribute the hand-force concentration over a greater surface area, be comfortable to hold, reduce compressive forces on the hand surface, be well-rounded, be as large as will fit the hand comfortably, be covered with a compliant material such as plastic or rubber, and be long enough to distribute forces over the large fleshy areas at the base of the thumb and little finger. The use of ergonomically designed hand tools significantly reduces the risk of CTDs.

The Occupational Safety and Health Administration (OSHA) defines CTDs as “health disorders arising from repeated biomechanical stress due to ergonomic hazards.” Simply put, the pain, tingling, numbness, and/or weakness associated with CTDs are the result of irritation (inflammation) and swelling of nerves, tendons, ligaments, and linings of joint spaces from repeated overuse of the affected structures. Other terms for Cumulative Trauma Disorders are repetitive motion injury, occupational overuse syndrome, and repetitive strain injury.

CTDS are common in the barber and hair stylist industry (J. Occup. Med. Toxicol., Aug. 17, 2019; 14, 24; doi: 10.1186/s12995-019-0244-y). Chronic pain, missed work, and medical expenses related to CTDS are a concern for the professional and often lead to early retirement from the field. CTDS are also a concern for the employers of professional barbers and hair stylists due to the associated work compensation claims, staff downtime and staff turnover.

Currently there is a need for devices and methods that are useful for reducing Cumulative Trauma Disorders in the barber and hair stylist industry. Such devices and methods could reduce irritation (inflammation), and/or the swelling of nerves, tendons, ligaments, and linings of joint spaces from repeated overuse of the affected structures. This in turn could reduce the chronic pain, missed work, and medical expenses related to CTDS for barbers and hair stylists.

### SUMMARY

In one embodiment, devices and methods that are useful for reducing Cumulative Trauma Disorders in the barber and hair stylist industry are provided.

In one embodiment, an ergonomic comb holder is provided, which is an adaptive tool for barbers and hair stylists, which can be placed over the end of any size comb for the purpose of widening the grip surface and thereby decreasing pincher grip stress and wrist flexion experienced while holding a comb for prolonged periods of time.

In one embodiment, a device for reducing a cumulative trauma disorder associated with repeatedly using a comb having a handle, comprising a sleeve that is configured to receive the handle, wherein the sleeve is further configured to alter the size and shape of the handle once received therein to reduce stress when the comb is gripped is provided.

In one embodiment, a method comprising, reducing stress caused when a barber or hair stylist grips a comb by attaching a devise to the comb that alters gripping and thereby reduces the stress is provided.

In one embodiment, a kit comprising: packaging material; a device as described herein; and instructions for inserting a handle of a comb into the device to reduce stress when the comb is gripped is provided.

In one embodiment, a method comprising, cutting hair using a comb that has a handle that is inserted into a device as described herein is provided.

In one embodiment, a comb having a handle that is inserted into a device as described herein is provided.

### BRIEF DESCRIPTION OF DRAWINGS

FIG. 1 shows a standard barber comb with a handle in accordance with some embodiments of the present disclosure;

FIG. 2 shows a standard flat-top barber comb with a handle in accordance with some embodiments of the present disclosure;

FIG. 3 shows a device, which in some embodiments is a sleeve, having a top that has an opening that is suitable to receive the handle of a standard barber comb or the handle of a standard flat-top barber comb, for example, in accordance with some embodiments of the present disclosure;

FIG. 4 shows a top view of a device having an opening that is suitable to receive the handle, for example, the handle shown in FIG. 1 or FIG. 2, in accordance with some embodiments of the present disclosure;

FIG. 5 shows a standard barber comb having the device mounted on the handle in accordance with some embodiments of the present disclosure;

FIG. 6 shows an angled top view of a standard barber comb having the device mounted on the handle in accordance with some embodiment of the present disclosure; and

FIG. 7 shows a bottom view of a standard barber comb having the device mounted on the handle in accordance with some embodiments of the present disclosure.

FIG. 8 shows a kit including a packaging material, a device, and instructions in accordance with some embodiments of the present disclosure.

FIG. 9A shows a top view of a sleeve including a collar.

FIG. 9B shows a top view of a handle including a cross-section diameter.

FIG. 10 illustrates a device of the invention having indentations and a rough surface.

### DETAILED DESCRIPTION

Reference will now be made in detail to the exemplary embodiments of the present disclosure described below and illustrated in the accompanying drawings. Wherever possible, the same reference numbers will be used throughout to refer to same or like parts.

While the present invention is described herein with reference to illustrative embodiments for particular applications, it should be understood that the invention is not limited thereto. Those having ordinary skill in the art and access to the teachings provided herein will recognize additional modifications, applications, embodiments, and substitution of equivalents, that all fall within the scope of the disclosure. Accordingly, the disclosure is not to be considered as limited by the foregoing or following descriptions.

As used herein, the term “about” means plus-or-minus 10% of the stated value.

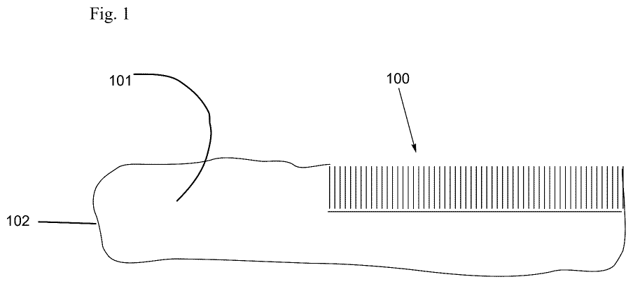

FIG. 1 shows a standard barber comb 100 with a handle 101 and an end 102 in accordance with some embodiments of the present disclosure.

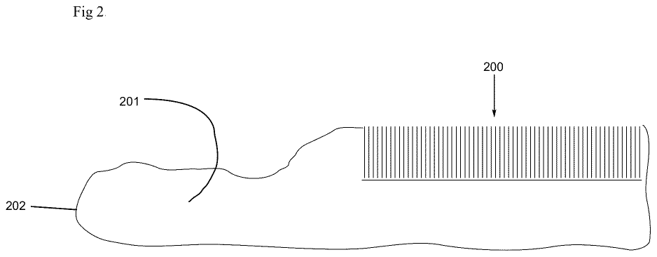

FIG. 2 shows a standard flat-top barber comb 200 with a handle 201 and an end 202 in accordance with some embodiments of the present disclosure.

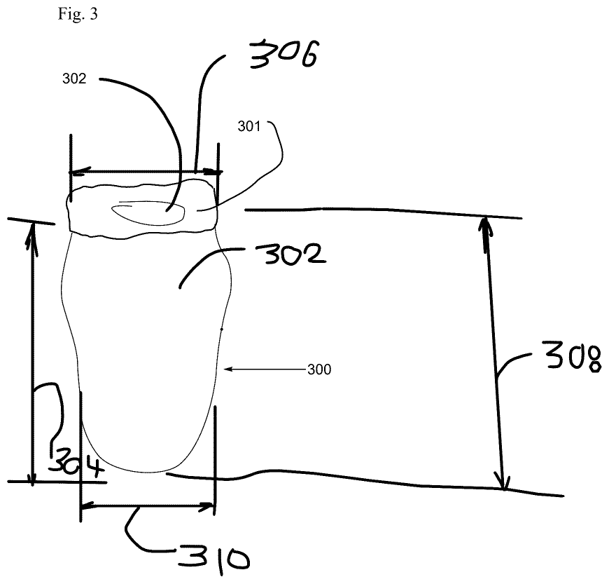

FIG. 3 shows a device 300, which in some embodiments is a sleeve 302, having a top 301 that has an opening 302 that is suitable to receive the handle 101 (shown in FIG. 1) of a standard barber comb 100 (shown in FIG. 1) or the handle 201 (shown in FIG. 2) of a standard flat-top barber comb 200 (shown in FIG. 2), for example, in accordance with some embodiments of the present disclosure. The device 300 is not limited to use with a particular comb. Any comb that is gripped in use is suitable for use with the device 300 and the sleeve 302. The sleeve 302 is configured to receive the handle 101 or the handle 201, in some embodiments. The sleeve 302 has a size 304 and a shape 306 and is deformable and further configured to alter the size 304 and shape 306 of the sleeve 302. In some embodiments, the shape 306 is substantially rectangular. In some embodiments the shape 306 is substantially cylindrical.

In operation, the device 300 reduces a cumulative trauma disorder associated with a stress resulting from repeatedly using the standard barber comb 100 or the flat-top barber comb 200, for example. In operation, the sleeve 302 is deformable and further configured to alter the size 304 and shape 306 of the of the sleeve 302, once received by a handle 101 or 202 to reduce the stress when the sleeve 302 is gripped by a barber.

In some embodiments the sleeve 302 of the device 300 includes a high-density foam. In some embodiments, the sleeve 302 of the device 300 includes a soft rubber or a blow molded plastic. In some embodiments, the sleeve 302 has a length 308 of between about three inches and about five inches. In some embodiments, the sleeve 302 has a width 310 of between about one inch and three inches. In some embodiments, the sleeve 302 has a length 308 of about four-inches and a width of about two inches.

In operation, the stress induced by gripping a standard barber comb 100, for example, the stress is in the hand, wrist, or forearm of a person holding the standard barber comb 100 or the standard flat-top comb 200. In operation, the sleeve 302 can decrease pincher grip stress or wrist flexion experienced while holding the comb once the comb is received by a handle 101 or a handle 102, for example.

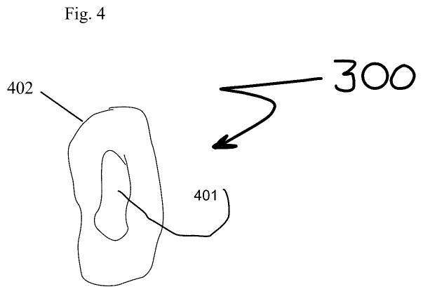

FIG. 4 shows a top view of a device 300 invention having a side 402 and an opening 401 that is suitable to receive the handle 101 (shown in FIG. 1) or the handle 201 (shown in FIG. 2) and an external surface 402 in accordance with some embodiments of the present disclosure. In some embodiments, the opening 401 is configured to receive the end 102 or 202 of the comb handle. In some embodiments, the opening does not extend through the external surface 402 of the device.

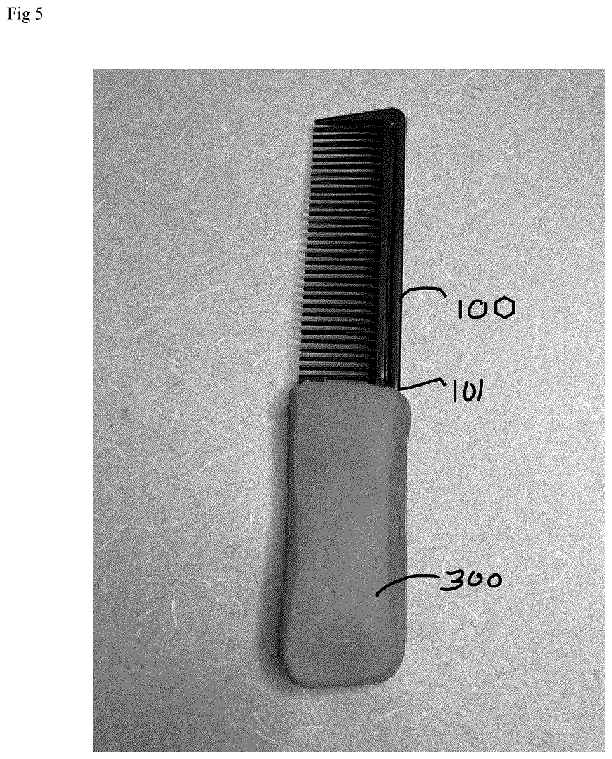

FIG. 5 shows a standard barber comb 100 having the device 300 mounted on the handle 101 in accordance with some embodiments of the present disclosure.

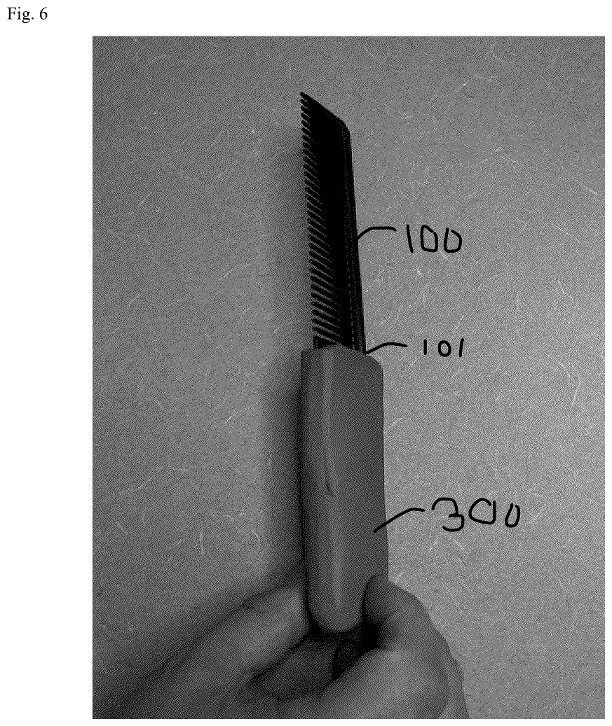

FIG. 6 shows an angled top view of a standard barber comb 100 having the device 300 mounted on the handle 101 in accordance with some embodiment of the present disclosure.

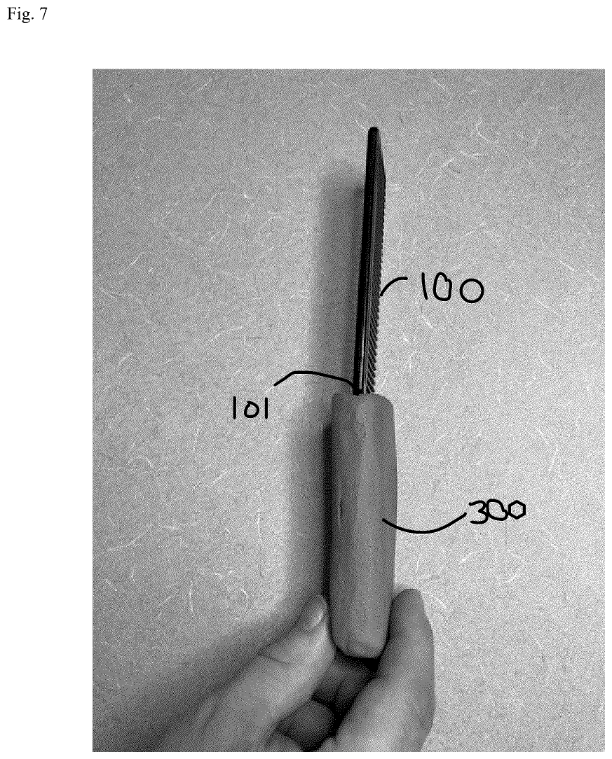

FIG. 7 shows a bottom view of a standard barber comb 100 having the device 300 mounted on the handle 101 in accordance with some embodiments of the present disclosure.

In some embodiments, a method includes cutting hair using a comb that has a handle 101 (shown in FIG. 1) that is inserted into a device 300. In some embodiments, the comb has a handle that is inserted into a device. In some embodiments, the comb is a standard barber comb. In some embodiments, the comb is a standard flat-top barber comb.

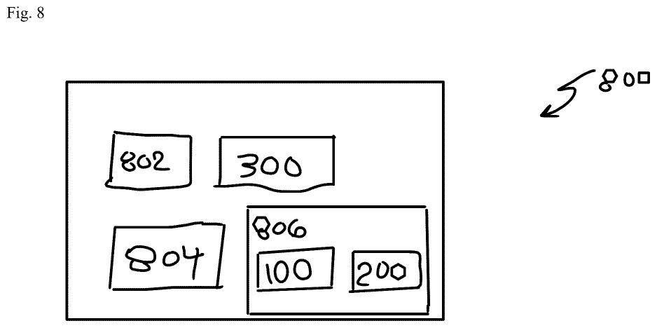

FIG. 8 shows a kit 800 including a packaging material 802, a device 300, and instructions 804 in accordance with some embodiments of the present disclosure. In some embodiments, the kit 800 further comprises a comb 806. In some embodiments, the comb 806 is a standard barber comb 100 or a standard flat-top barber comb 200.

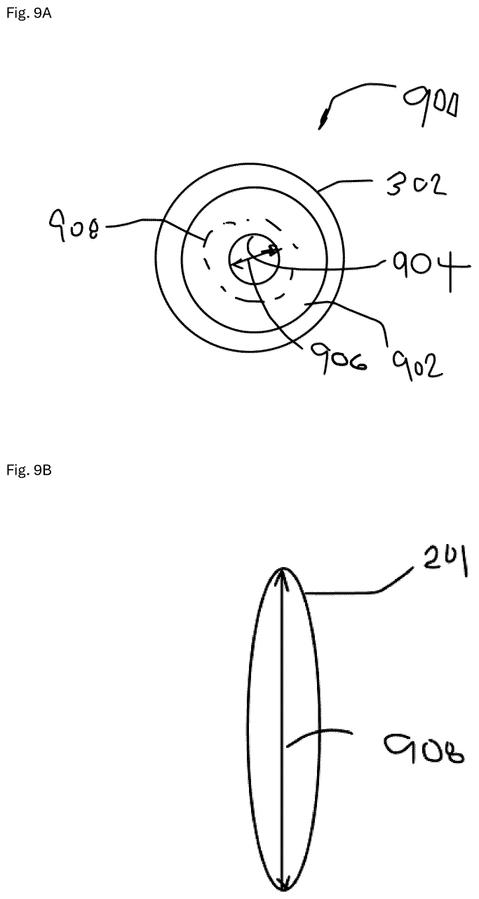

FIG. 9A shows a top view 900 of sleeve 302 (shown in FIG. 3) including a collar 902 to provide a guide to receive the handle 201 (shown in FIG. 2). The collar 902 includes an opening 904 to receive the handle 201. In some embodiments, the collar 902 is made from a flexible material and has a diameter 906 slight less than the cross-section diameter 908 (shown in FIG. 9B) of the handle 201. Dashed line 908 shows the inside opening of the sleeve 302.

FIG. 9B shows a top view of the handle 201 (shown in FIG. 2) including a cross-section diameter 908. The cross-section diameter of the handle 201 is the largest cross-section measurement of the handle 201.

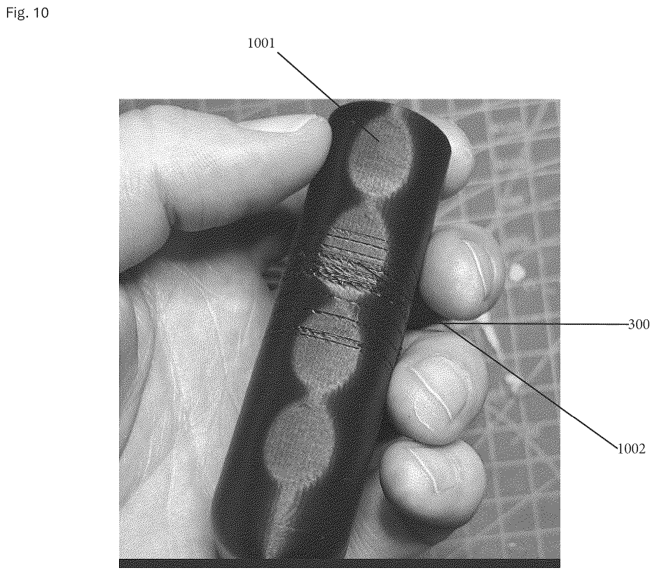

FIG. 10 shows a device 300 of the invention having indentations 1001 that can receive fingers and an optional rough surface 1002 to improve gripping. In operation, the indentations 101 receives a user's fingers and improve gripping of the device 300. In some embodiments, the indentations 1001 are between about 0.1 inches and about 0.25 inches, and, in operation receive a user's fingers. Further, in some embodiments, the optional rough surface 1002 has a surface roughness Ra of between about 10 micrometers and about 50 micrometers, between about 50 micrometers and about 100 micrometers, between about 100 micrometers and about 200 micrometers, between about 200 micrometers and 500 micrometers, or between about 10 micrometers and about 500 micrometers.

The device of the invention can be prepared using any suitable method. In one embodiment, the device is prepared by 3D-printing. In one embodiment, the invention provides a method for preparing a device of the invention comprising 3D-printing the device.

The device of the invention can be made from any suitable injectable, moldable, or printable material, such as, for example, an injectable, moldable, or printable foam. The device can be any suitable color, and may include one or more custom indicia, such as, for example, letters, initials, or logos.

The invention will now be illustrated by the following non-limiting Examples.

### EXAMPLES

### Example 1

A professional barber with 20 plus years of experience, who had experienced CTDS including finger, hand, wrist, arm, and neck symptoms, developed a device of the invention (shown in FIGS. 5-7 with a comb inserted therein) for use on clients. After using the device over a period of 4 months, the barber experienced a significant improvement in the CTDS symptoms.

### Example 2

A universal comb handle was produced through a fully digital-to-physical workflow beginning with a ground-up CAD design that defines its ergonomic geometry, internal structure, and attachment interface for multiple comb types. Once the model was finalized, it was exported for additive manufacturing and printed on a Bambu A1 3D printer using TPE-83A, a flexible elastomer chosen for its durability, comfort, and ability to absorb repetitive motion forces. The printing process formed the handle as a single integrated component with built-in grip contours and stress-reducing flex zones. After printing, the part was cooled, lightly post-processed to remove any support artifacts, and tested for fit and function with standard comb heads. The resulting product provided a universal, adaptable handle that significantly reduces repetitive strain on the user's arm joints by redistributing force and improving grip ergonomics.

All publications, patents, and patent documents are incorporated by reference herein, as though individually incorporated by reference. The invention has been described with reference to various specific and preferred embodiments and techniques. However, it should be understood that many variations and modifications may be made while remaining within the spirit and scope of the invention.

Reference throughout this specification to “an embodiment,” “some embodiments,” or “one embodiment.” means that a particular feature, structure, material, or characteristic described in connection with the embodiment is included in at least one embodiment of the present disclosure. Thus, the appearances of the phrases such as “in some embodiments,” “in one embodiment,” or “in an embodiment,” in various places throughout this specification are not necessarily referring to the same embodiment of the present disclosure. Furthermore, the particular features, structures, materials, or characteristics may be combined in any suitable manner in one or more embodiments.

Although explanatory embodiments have been shown and described, it would be appreciated by those skilled in the art that the above embodiments cannot be construed to limit the present disclosure, and changes, alternatives, and modifications can be made in the embodiments without departing from spirit, principles and scope of the present disclosure.

What is claimed is:

1. A device for reducing a cumulative trauma disorder associated with a stress resulting from repeatedly using a comb having a handle having a size and a shape, comprising a sleeve that is configured to receive the handle, wherein the sleeve is deformable further configured to alter the size and the shape of the handle once received therein to reduce the stress when the sleeve is gripped after the sleeve has received the handle.

2. The device of claim 1, which comprises a high-density foam.

3. The device of claim 1, which comprises a soft rubber or a blow molded plastic.

4. The device of claim 1, which is about 3-5 inches long and about 1-3 inches wide.

5. The device of a claim 1, which is about 4 inches long and about 2 inches wide.

6. The device of claim 1, which further comprises a collar that provides a guide to receive the handle.

7. The device of a claim 1, wherein the stress is in the hand, wrist, or forearm of a person holding the comb.

8. The device of claim 1, wherein the sleeve can decrease pincher grip stress or wrist flexion experienced while holding the comb once the comb is received therein.

9. A method comprising, reducing stress caused when a barber or hair stylist grips a comb by attaching a devise to the comb that alters gripping and thereby reduces the stress.

10. The method of claim 9, wherein the devise is a devise that is described in claim 1

11. The method of claim 9, wherein the stress is in a hand, wrist, or forearm.

12. The method of claim 9, wherein the likelihood of the barber or the hair stylist developing carpal tunnel syndrome is reduced.

13. The method of claim 12, wherein the likelihood of the barber or the hair stylist developing carpal tunnel syndrome is reduced by at least about 25%.

14. A kit comprising:
packaging material;
the device of claim 1; and
instructions for inserting a handle of a comb into the device to reduce stress when the comb is gripped.

15. The kit of claim 14 that further comprises a comb.

16. The kit of claim 15, wherein the comb is a standard barber comb.

17. The kit of claim 15, wherein the comb is a standard flat-top barber comb.

18. A method comprising, cutting hair using a comb that has a handle that is inserted into a device as described in claim 1.

19. A comb having a handle that is inserted into a device as described in claim 1.

20. The comb of claim 19, which is a standard barber comb or a standard flat-top barber comb.
